(19) United States
(12) Patent Application Publication
(10) Pub. No.: US 2010/0138822 A1
(43) Pub. Date: Jun. 3, 2010

(54) PATCH APPLICATION APPARATUS AND PATCH APPLICATION METHOD

(75) Inventor: Seiya MIYAZAKI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/625,601

(22) Filed: Nov. 25, 2009

(30) Foreign Application Priority Data
Dec. 2, 2008 (JP) 2008-307662

(51) Int. Cl. G06F 9/44

(52) U.S. Cl. 717/168

(57) ABSTRACT

A patch application apparatus for applying plural software patches to a computer system includes a relation checker that determines dependencies among the plural software patches, and a patch applier that applies first software patches among the plural software patches in parallel to the computer system, each of the first software patches being determined to have no dependency on any other software patch of the plural software patches by the relation checker, and that applies second software patches among the plural software patches in order according to the dependencies of the second software patches to the computer system, the second software patches being determined to have the dependencies thereamong by the relation checker.

### CROSS-REFERENCE TO RELATED APPLICATION

This application is based upon and claims the benefit of priority of the prior Japanese Patent Application No. 2008-307662, filed on Dec. 2, 2008, the entire contents of which are incorporated herein by reference.

### FIELD

The embodiments discussed herein are related to a patch application apparatus, a patch application method and computer readable medium storing patch application program.

### BACKGROUND

A patch is a small piece of software to fix or update a computer program. In order to fix or update a part of a program, a patch including replacement data for the part is generated and applied to the program. When applying plural patches, the plural patches are applied serially one by one.

### [PATENT DOCUMENT 1] Japanese Laid-open Patent Publication No. 01-188938

### [PATENT DOCUMENT 2] Japanese Laid-open Patent Publication No. 2004-102379

### SUMMARY

According to an aspect of an invention, a patch application apparatus for applying plural software patches to a computer system includes a relation checker that determines dependencies among the plural software patches, and a patch applier that applies first software patches among the plural software patches in parallel to the computer system, each of the first software patches being determined to have no dependency on any other software patch of the plural software patches by the relation checker, and that applies second software patches among the plural software patches in order according to the dependencies of the second software patches to the computer system, the second software patches being determined to have the dependencies thereamong by the relation checker.

### BRIEF DESCRIPTION OF DRAWINGS

FIG. 1 is a diagram illustrating an outline of a patch application apparatus according to an embodiment of the present invention;

FIGS. 2 and 3 are diagrams illustrating an example of a data structure of a patch according to an embodiment of the present invention;

FIG. 4 is a block diagram illustrating an example of a system configuration of a patch application apparatus according to an embodiment of the present invention;

FIG. 5 is a diagram illustrating an example of a data structure of data stored in a system data storage of a patch application apparatus according to an embodiment of the present invention;

FIG. 6 is a diagram illustrating an example of a data structure of data stored in an applied patch data storage of a patch application apparatus according to an embodiment of the present invention;

FIGS. 7A, 7B, and 7C are diagrams illustrating an example of a data structure of data stored in a patch storage of a patch application apparatus according to an embodiment of the present invention;

FIGS. 8, 9A, and 9B are diagrams illustrating an example of a data structure of a combined patch according to an embodiment of the present invention;

FIG. 10 is a sequence diagram illustrating an example of an entire operation flow of a patch application apparatus according to an embodiment of the present invention;

FIG. 11 is a diagram illustrating components of a patch application apparatus according to an embodiment of the present invention;

FIG. 12 is a flowchart illustrating an example of an operation flow of an entire process performed by a patch application apparatus according to an embodiment of the present invention;

FIG. 13 is a flowchart illustrating an example of an operation flow of a process performed by a combining controller of a patch application apparatus according to an embodiment of the present invention;

FIG. 14 is a flowchart illustrating an example of an operation flow of a process of applying patches included in a combined patch performed by a combined patch applier of a patch application apparatus according to an embodiment of the present invention;

FIGS. 15A and 15B are diagrams illustrating an effect of a patch application apparatus according to an embodiment of the present invention;

FIG. 16 is a flowchart illustrating an example of an operation flow of a conventional patching process;

FIG. 17 is a diagram illustrating an example of a conventional patching process; and

FIG. 18 is a diagram illustrating a computer that executes a patch program according to an embodiment of the present invention.

### DESCRIPTION OF EMBODIMENTS

In conventional technologies, it is difficult to apply plural patches efficiently. For example, in order to apply plural patches, the patches are serially applied one by one. This requires for applying the plural patches the total amount of time of applying each of the plural patches.

It is preferable to provide a patch application apparatus capable of applying patches efficiently.

With reference to attached drawings, embodiments of the patch application apparatus will be discussed in detail below. In the following discussion, an outline of a patch application apparatus according to the embodiments, an example of a data structure of a patch, an example of a system configuration of a patch application apparatus, and an example of an operation flow of a patch application apparatus will be discussed.

Outline of Patch Application Apparatus

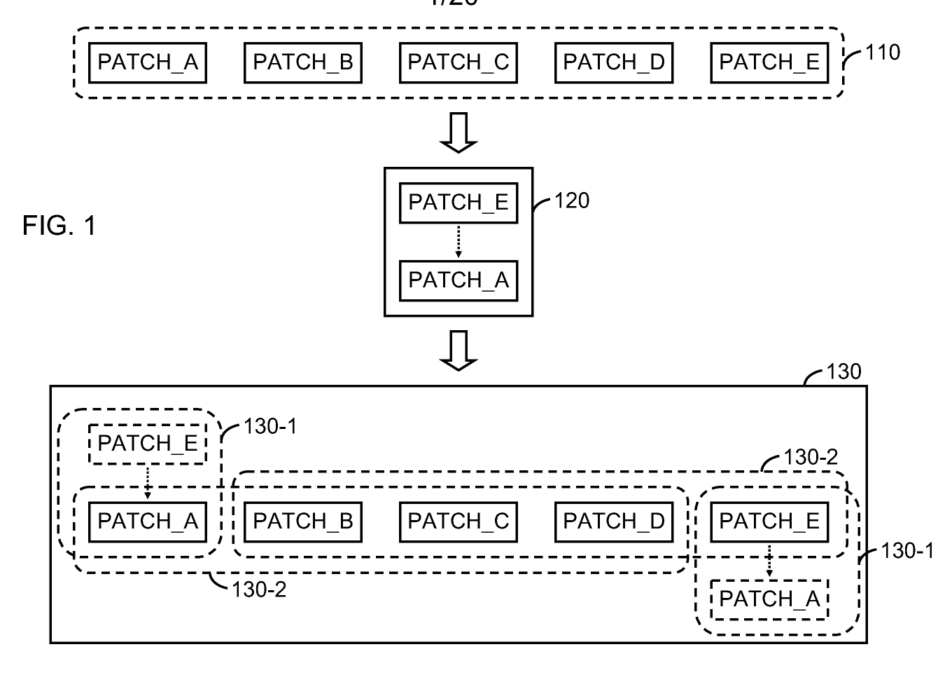

FIG. 1 is a diagram illustrating an outline of a patch application apparatus according to an embodiment of the present invention. With reference to FIG. 1, the outline of a patch application apparatus according to a first embodiment will be discussed.

As illustrated in FIG. 1, the patch application apparatus according to the first embodiment checks and determines dependencies among plural patches to be applied to a computer system. For example, in FIG. 1, in order to apply patches 110 including Patch_A, Patch_B, Patch_C, Patch_D, and Patch_E to a computer system, the patch application apparatus checks and determines dependencies among the patches 110. The patch application apparatus determines a dependency 120 between Patch_A and Patch_E in which Patch_E can be applied before Patch_A is applied. The patch application apparatus further determines that there is no dependency among other patches.

The patch application apparatus according to the first embodiment determines an order 130 for applying the patches 110. The patch application apparatus determines that patches having a dependency should be applied serially in accordance with the dependency. For example, the patch application apparatus applies Patch_E and Patch_A one by one in an order 130-1.

In contrast, the patch application apparatus determines that patches having no dependency may be applied in parallel 130-2. Thus, the patch application apparatus applies some of the patches of Patch_A, Patch_B, Patch_C, and Patch_D in parallel and applies some of the patches of Patch_B, Patch_C, Patch_D, and Patch_E in parallel.

The patch application apparatus according to the first embodiment controls patching so as to apply plural patches in parallel except for patches, Patch_E and Patch_A for example, having a dependency with each other.

In this way, the patch application apparatus according to the first embodiment may apply patches efficiently. Specifically, the patch application apparatus may apply patches with no dependency in parallel, which may reduce the amount of time required for patching. In addition, the patch application apparatus may reduce the amount of time for suspending the operations of the computer system by determining the dependency.

Example of Data Structure of Patch

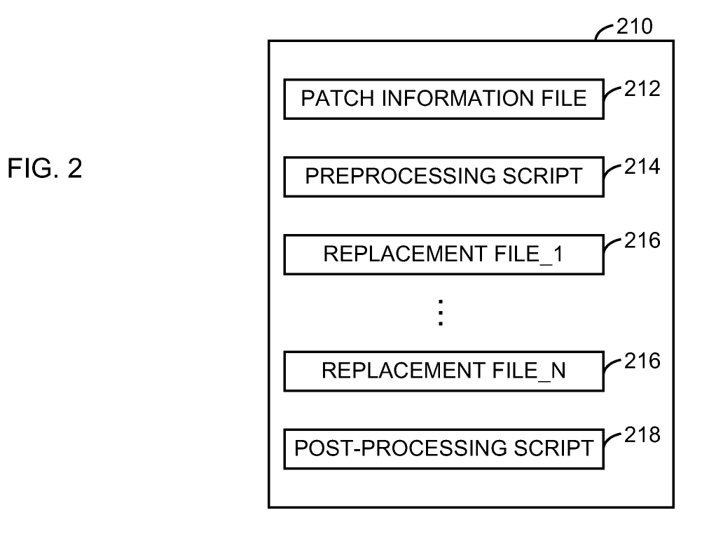

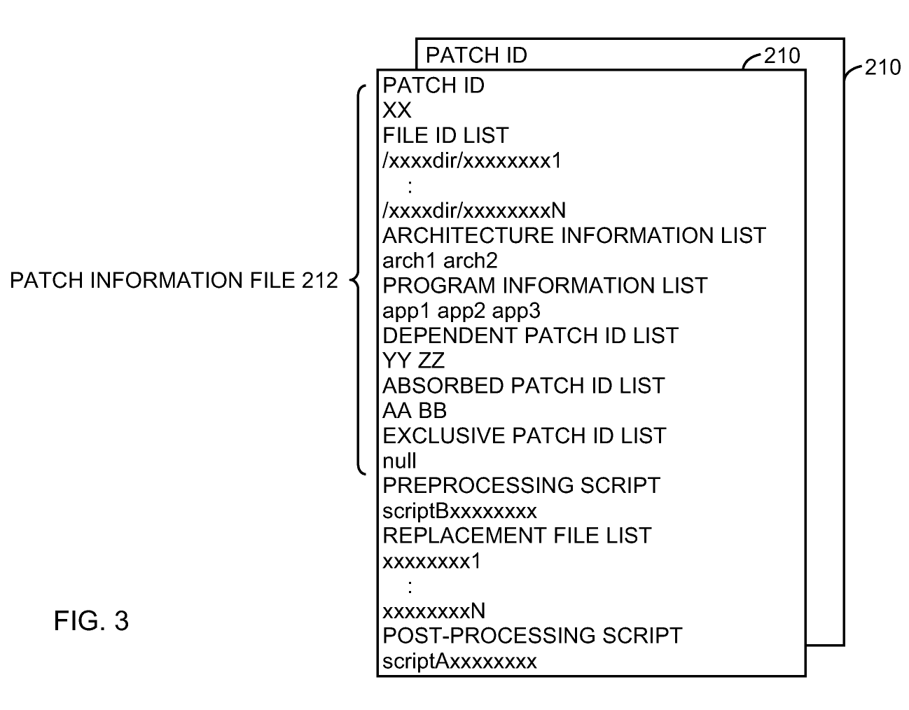

FIGS. 2 and 3 are diagrams illustrating an example of a data structure of a patch according to an embodiment of the present invention. With reference to FIGS. 2 and 3, an example of a data structure of a patch will be discussed. As illustrated in FIG. 2, each of the patches 210 includes patch information file 212, preprocessing script 214, replacement files 216, and post-processing script 218.

The patch information file 212 includes data regarding the own patch. In the example illustrated in FIG. 3, the patch information file 212 includes a patch identifier (ID), a file ID list, an architecture information list (also denoted by “ARCHITECTURE INFO. LIST” in the drawings), and a program information list (also denoted by “PROGRAM INFO. LIST” in the drawings). The patch information file 212 also includes a dependent patch ID list, an absorbed patch ID list, and an exclusive patch ID list.

The patch ID is an identifier which distinguishes the own patch from other patches. In the example illustrated in FIG. 3, “XX” corresponds to the patch ID. A patch identified with a patch ID “XX” is referred to as a patch “XX”.

The file ID list is a list of file IDs capable of identifying files to be replaced by the patching. In the example illustrated in FIG. 3, a list of “/xxxxdir/xxxxxxxx1” to “/xxxxdir/xxxxxxxxN” corresponds to the file ID list. In other words, when the patch “XX” is applied, the files “/xxxxdir/xxxxxxxx1” to “xxxxdir/xxxxxxxxN” are replaced.

The architecture information list is a list of architecture information capable of identifying hardware architectures of computer systems. In the example illustrated in FIG. 3, the architecture information list includes architecture information “arch1” and “arch2”. In other words, the patch “XX” is applicable to a computer system having a hardware architecture identified with the architecture information “arch1” or “arch2”. The hardware architecture may correspond to, for example, the type of a central processing unit (CPU) as an arithmetic processing unit or the type of a server as an information processing apparatus.

The program information list is a list of program information capable of identifying programs to which the patch is applicable. In the example illustrated in FIG. 3, the program information list includes program information “app1”, “app2”, and “app3”. In other words, the patch “XX” is applicable to a program identified by the program information “app1”, “app2” or “app3”.

The dependent patch ID list is one kind of relational data specifying relation with other patches. Specifically, the dependent patch ID list is a list of patch IDs of dependent patches, i.e., other patches which the own patch depends on. The dependent patches are patches that are assumed to be preconditions to apply the own patch. In other words, when the own patch is applied, the dependent patches are required to have been already applied. In the example illustrated in FIG. 3, the patch IDs “YY” and “ZZ” correspond to the “dependent patches. That is, when the patch “XX” is applied, the patches “YY” and “ZZ” are required to have already been applied.

The absorbed patch ID list is one kind of relational data specifying relation with other patches. Specifically, the absorbed patch ID list is a list of patch IDs of absorbed patches, i.e., other patches that have been absorbed into the own patch. The absorbed patches are patches included in the own patch, that is, when the own patch has been applied, the absorbed patches are assumed to have been also applied. In the example illustrated in FIG. 3, the patch IDs “AA” and “BB” correspond to the absorbed patches. In other words, when the patch “XX” has been applied, the patches “AA” and “BB” are assumed to have been also applied.

The exclusive patch ID list is one kind of relational data specifying relation with other patches. Specifically, the exclusive patch ID list is a list of patch IDs of exclusive patches, i.e., other patches that are in an exclusive relation with the own patch. The exclusive patches are patches that should not have been applied when the own patch is applied. In other words, when exclusive patches have already been applied, the own patch is not applied. In the example illustrated in FIG. 3, the exclusive patch ID list contains no ID (which is denoted by “null”), that is, there are no exclusive patches.

Referring back to FIG. 2, the replacement files are files to replace existing files by the patching. In the example illustrated in FIG. 3, files “xxxxxxxx1” to “xxxxxxxxN” contained in a replacement file list corresponds to the replacement files. In other words, the files corresponding to the file IDs contained in the “file ID list” are replaced with files contained in the replacement file list.

The preprocessing script 214 and post-processing script 218 are scripts describing processing details to be executed when the patch is applied and are executed before and after a file corresponding to a file ID included in the file ID list is replaced with a file contained in the replacement file list. For example, the preprocessing script 214 is executed before the replacement while the post-processing script 218 is executed after the replacement.

For example, the preprocessing script 214 or post-processing script 218 may describe a process for adding or changing an environmental variable. Furthermore, for example, the preprocessing script 214 may describe a process for holding a file to be replaced while the post-processing script 218 may describe a process for reflecting the patching to the user definition in the file to be replaced.

Thus, patching is implemented by processing on the replacement files 216, the preprocessing script 214, and the post-processing script 218 contained in the patch.

It is not necessarily the case that a patch includes all of the replacement files 216, the preprocessing script 214, and the post-processing script 218. A patch may only include some of the replacement files 216, the preprocessing script 214, and the post-processing script 218. For example, only a process may be performed for adding a new environmental variable to a definition file containing user definition in accordance with the post-processing script 218 or preprocessing script 214 without replacing the files in a patching.

System Configuration of Patch application apparatus

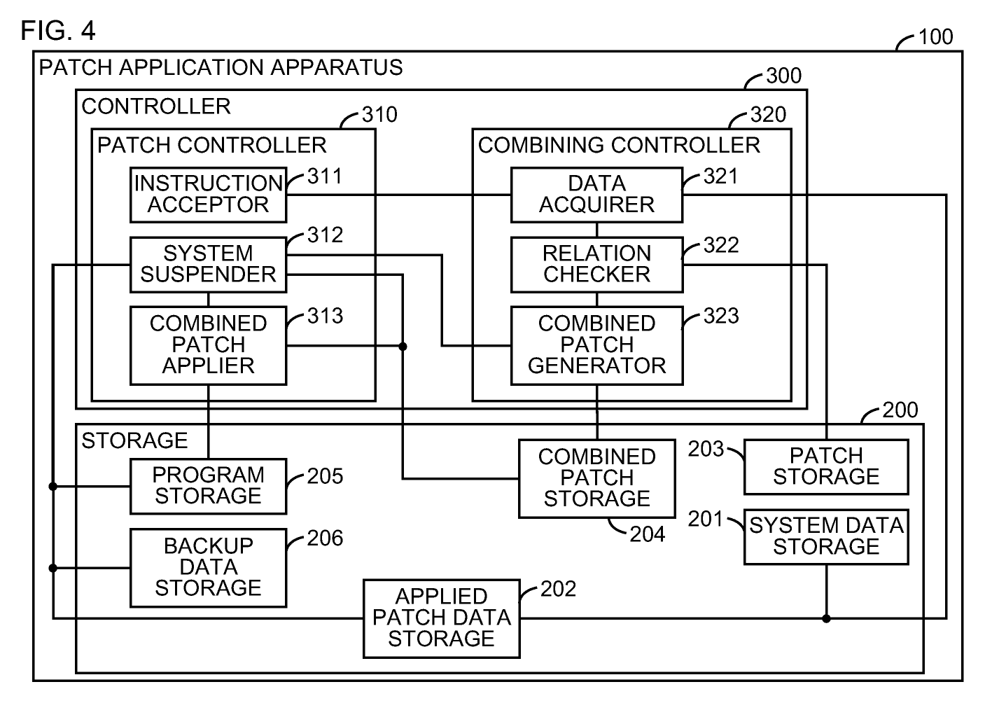

FIG. 4 is a block diagram illustrating an example of a system configuration of a patch application apparatus according to an embodiment of the present invention. With reference to FIG. 4, an example of a system configuration of a patch application apparatus 100 will be discussed. As illustrated in FIG. 4, the patch application apparatus 100 includes a storage 200 and a controller 300. Unless otherwise noted, it is assumed below that the patch application apparatus 100 applies a patch to a system of the patch application apparatus 100 itself.

The storage 200 connects to the controller 300 and stores data to be used in patching process executed by the controller 300. As illustrated in FIG. 4, the storage 200 includes a system data storage 201, an applied patch data storage 202, a patch storage 203, a combined patch storage 204, a program storage 205, and a backup data storage 206.

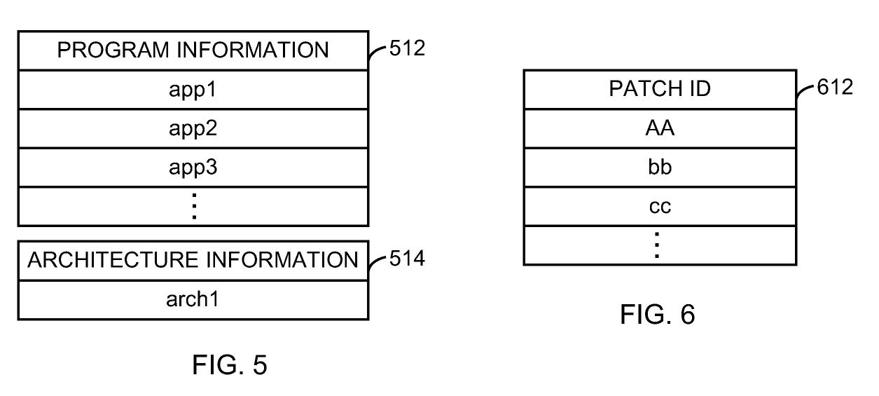

The system data storage 201 connects to an data acquirer 321, which will be discussed later, and stores data (referred to as system data) regarding the system to which a patch is applied. FIG. 5 is a diagram illustrating an example of a data structure of data stored in a system data storage of a patch application apparatus according to an embodiment of the present invention. As illustrated in FIG. 5, the system data storage 201 stores program information 512 of programs held in the patch application apparatus 100 and further stores an architecture information 514 of the hardware architecture of the patch application apparatus 100.

In the example illustrated in FIG. 5, the system data storage 201 stores program information such as “app1”, “app2”, and “app3”. In other words, the patch application apparatus 100 holds programs identified with the program information “app1”, “app2”, and “app3”. The system data storage 201 further stores an architecture information “arch1”. In other words, the patch application apparatus 100 equips a hardware architecture identified with the architecture information “arch1”.

The programs held in the patch application apparatus 100 correspond to programs installed in the patch application apparatus 100 and may include an operating system (OS) and application programs.

The programs held in the patch application apparatus 100 are to be applied with a patch, and the patch application apparatus 100 applies a patch to the programs held in the patch application apparatus 100. The program information 512 and architecture information 514 stored in the system data storage 201 may be used by the data acquirer 321.

The applied patch data storage 202 connects to the data acquirer 321 and a combined patch applier 313, which will be discussed later, and stores data regarding the patches which have been already applied to the programs held in the patch application apparatus 100.

FIG. 6 is a diagram illustrating an example of a data structure of data stored in an applied patch data storage of a patch application apparatus according to an embodiment of the present invention. The applied patch data storage 202 stores patch IDs 612 of the patches which have been already applied to the programs held in the patch application apparatus 100. In the example illustrated in FIG. 6, the applied patch data storage 202 stores patch IDs such as “AA”, “bb”, and “cc”. In other words, the patch application apparatus 100 has already applied the patches “AA”, “bb”, and “cc”.

The patch IDs 612 of applied patches are stored in the applied patch data storage 202 by the combined patch applier 313 and used by the data acquirer 321.

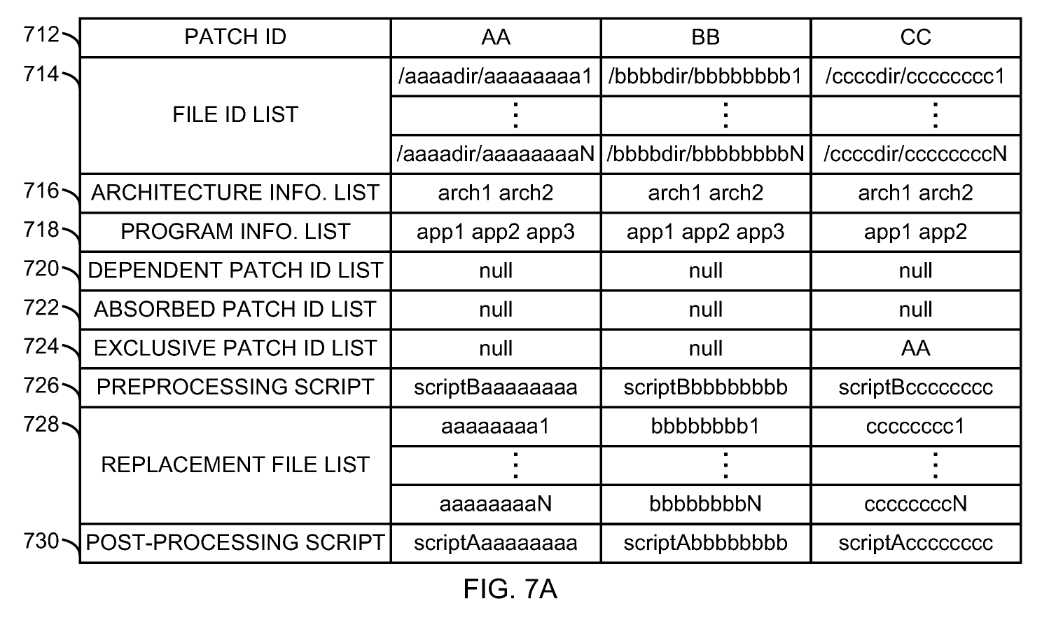

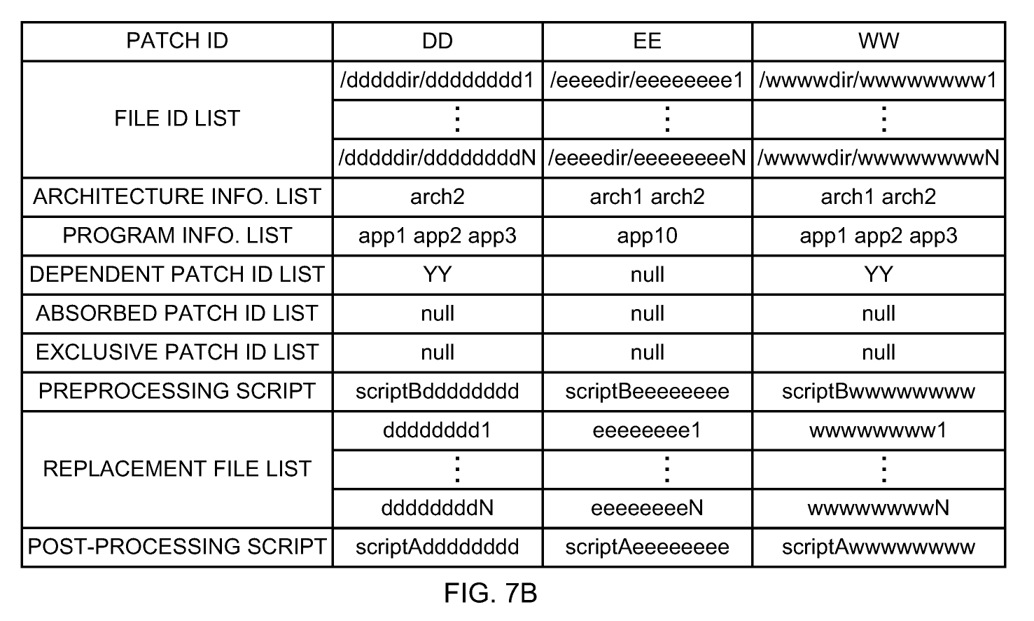

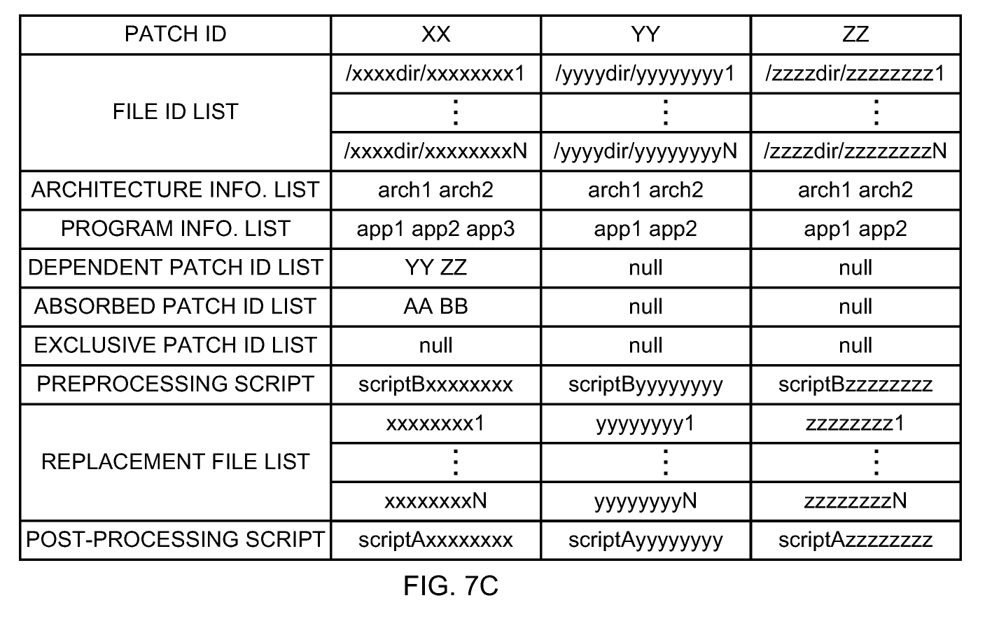

The patch storage 203 connects to a relation checker 322, which will be discussed later. FIGS. 7A, 7B, and 7C are diagrams illustrating an example of a data structure of data stored in a patch storage of a patch application apparatus according to an embodiment of the present invention. The patch storage 203 stores patches, for example, patches identified with patch IDs “AA”, “BB”, and “CC”, as illustrated in FIG. 7A.

For example, a patch stored in the patch storage 203 includes a patch ID 712, a file ID list 714, an architecture information list 716, a program information list 718, a dependent patch ID list 720, an absorbed patch ID list 722, and an exclusive patch ID list 724 as illustrated in FIGS. 7A, 7B, and 7C. The patch stored in the patch storage 203 further includes a preprocessing script 726, a replacement file list 728, and a post-processing script 730.

In the example illustrated in FIG. 7A, the patch “AA” stored in the patch storage 203 includes a patch ID “AA”, a file ID list containing file IDs “/aaaadir/aaaaaaaa1” to “/aaaadir/aaaaaaaaN”, and an architecture information list containing architecture information “arch1” and “arch2”. The patch “AA” includes a program information list containing program information “app1”, “app2”, and “app3”. The patch “AA” includes a dependent patch ID list, an absorbed patch ID list, and an exclusive patch ID list, which contain no patch ID, respectively. The patch “AA” includes a preprocessing script “scriptBaaaaaaaa”, a replacement file list containing files “aaaaaaaa1” to “aaaaaaaaN”, and a pos-processing script “scriptAaaaaaaaa”.

For example, an administrator who manages the patch application apparatus 100 may store patches in the patch storage 203. Alternatively, when new patches are transmitted from a delivery source of the programs held in the patch application apparatus 100, the patch application apparatus 100 may receive the new patches and store them in the patch storage 203.

The patches stored in the patch storage 203 are used by the relation checker 322.

The combined patch storage 204 connects to an system suspender 312, the combined patch applier 313, and a combined patch generator 323, which will be discussed later. The combined patch storage 204 stores a combined patch generated by combining plural patches into one combined patch. A combined patch is generated by the combined patch generator 323, stored in the combined patch storage 204 by the combined patch generator 323, used by the system suspender 312 or the combined patch applier 313, and deleted by the combined patch applier 313, for example.

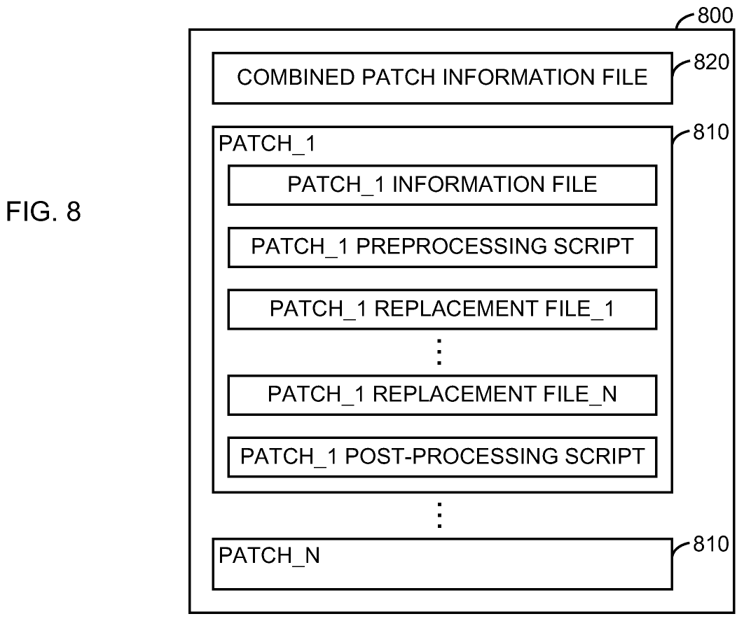

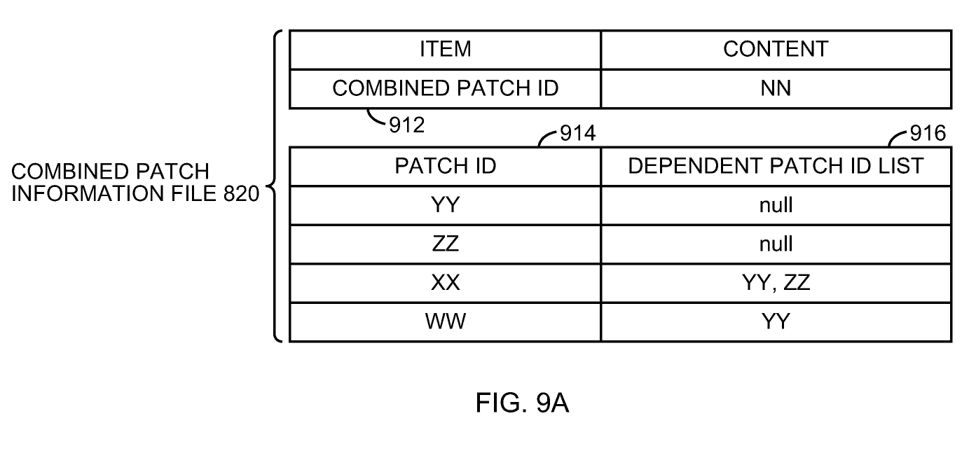

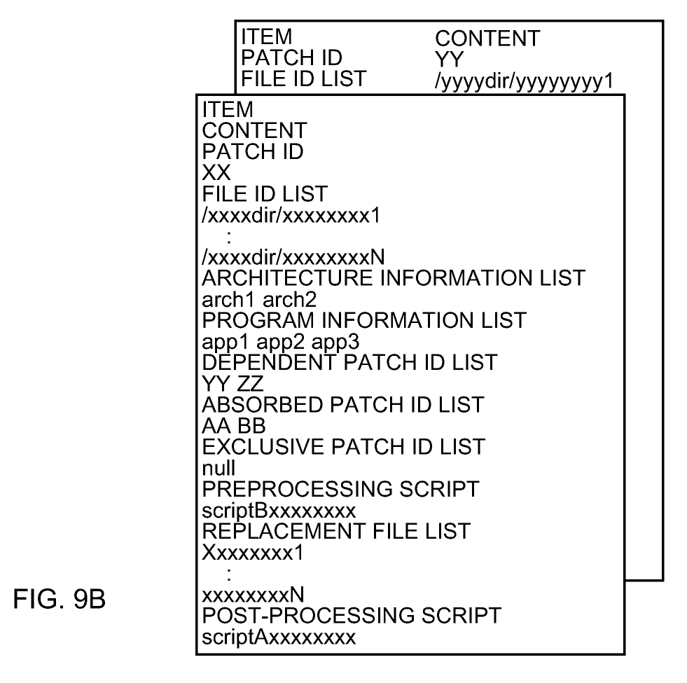

FIGS. 8, 9A, and 9B are diagrams illustrating an example of a data structure of a combined patch according to an embodiment of the present invention. With reference to FIGS. 8, 9A, and 9B, an example of a data structure of a combined patch stored in the combined patch storage 204 will be discussed. As illustrated in FIG. 8, a combined patch 800 includes a combined patch information file 820 and plural patches 810. The combined patch 800 illustrated in FIG. 8 includes N patches, for example.

The combined patch information file 820 is an information file regarding the combined patch 800. The combined patch information file 820 includes a combined patch ID 912 and patch IDs 914. Each patch ID 914 is associated with a dependent patch ID list 916, as illustrated in FIG. 9A. The combined patch ID 912 is an identifier capable of identifying a combined patch 800. For example, the combined patch ID is “NN” in the example illustrated in FIG. 9A.

The correspondence between patch ID 914 and the dependent patch ID list 916 will be discussed. The patch IDs 914 contained in the combined patch information file 820 are patch IDs of patches 810 included in the combined patch 800. The dependent patch ID list 916 associated with each patch ID 914 is a dependent patch ID list of a patch identified with the each patch ID 914.

The program storage 205 connects to the system suspender 312 and the combined patch applier 313 and stores a program held in the patch application apparatus 100. Specifically, the program storage 205 stores programs identified with program information stored in the system data storage 201. In other words, the program storage 205 stores programs to which patches are to be applied.

From a program stored in the program storage 205, The system suspender 312 generates backup data for programs stored in the program storage 205. The combined patch applier 313 applies a combined patch to the programs stored in the program storage 205.

The backup data storage 206 connects to the system suspender 312. The backup data storage 206 stores the backup data for the programs stored in the program storage 205. The backup data stored in the backup data storage 206 is backup data of programs to be applied with patches. The backup data corresponds to files to be replaced when patches are applied. the system suspender 312 stores the backup data in the backup data storage 206.

The backup data storage 206 also stores patch deletion data to be used for deleting an applied patch. The patch deletion data corresponds to the backup data for the applied patch. The system suspender 312 stores the patch deletion data in the backup data storage 20.

The controller 300 connects to the storage 200. The controller 300 has an internal memory for storing programs defining patching operations, for example. The controller 300 performs various patching operations. As illustrated in FIG. 4, The controller 300 includes a patch controller 310 and a combining controller 320.

The patch controller 310 connects to the storage 200 and the combining controller 320. The patch controller 310 includes an instruction acceptor 311, the system suspender 312, and the combined patch applier 313. The patch controller 310 controls a process for applying a combined patch in cooperation with the combining controller 320. Specifically, the patch controller 310 applies a combined patch generated by the combining controller 320.

The combining controller 320 connects to the storage 200 and the patch controller 310. The combining controller 320 includes the data acquirer 321, the relation checker 322, and the combined patch generator 323. The combining controller 320 controls a process for applying a combined patch in cooperation with the patch controller 310. Specifically, the combining controller 320 generates a combined patch to be applied by the patch controller 310.

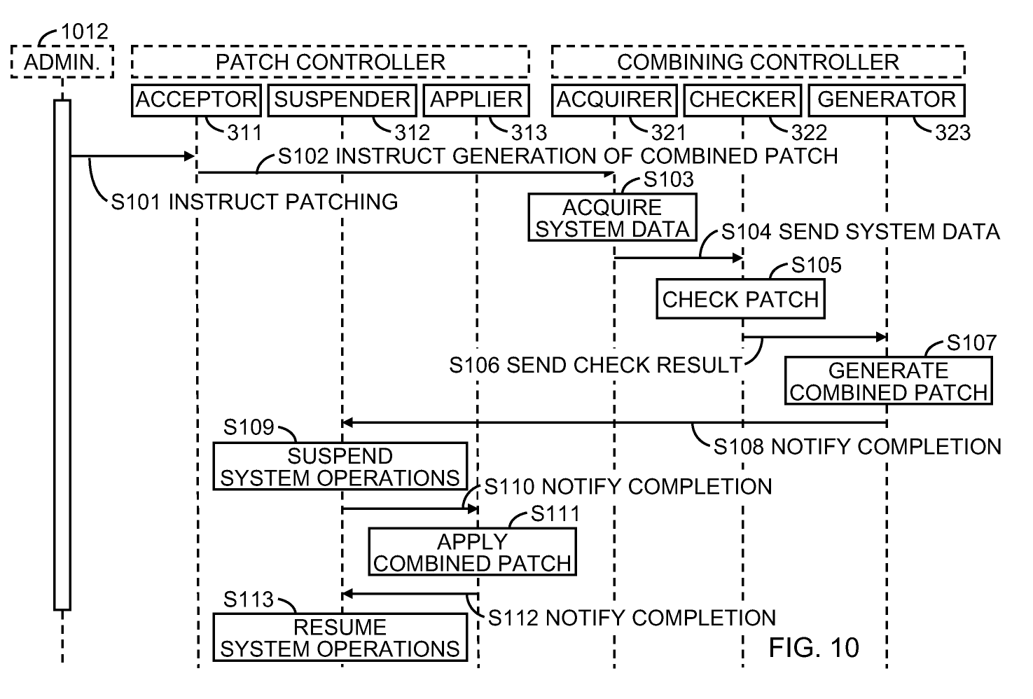

FIG. 10 is a sequence diagram illustrating an example of an entire operation flow of a patch application apparatus according to an embodiment of the present invention. With reference to FIG. 10, an example of an entire operation flow of the patch application apparatus 100 according to the first embodiment will be briefly discussed below. The relations of mutual connection and details in the operations are not discussed in the discussion with reference to FIG. 10.

In operation S101, an administrator (denoted by “ADMIN.” in the drawings) 1012, for example, transmits an instruction for applying patches.

In operation S102, the instruction acceptor (also denoted by “ACCEPTOR” in the drawings) 311 transmits an instruction for generating a combined patch to the data acquirer (also denoted by “ACQUIRER” in the drawings) 321.

In operation S103, the data acquirer 321 acquires system data and others. Specifically, the data acquirer 321 reads system data regarding the patch application apparatus 100 from the system data storage 201 and reads patch IDs of applied patches from the applied patch data storage 202.

In operation S104, the data acquirer 321 transmits the acquired system data and patch IDs to the relation checker (also denoted by “CHECKER” in the drawings) 322.

In operation S105, the relation checker 322 checks patches while the system is in-service, that is, the system operations are not suspended. In other words, the relation checker 322 checks, during system operations, the necessity of applying each patch stored in the patch storage 203. The relation checker 322 also determines for each patch applicable to the system, during system operations, other patches having dependencies with the each patch.

In operation S106, the relation checker 322 transmits the check result to the combined patch generator (also denoted by “GENERATOR” in the drawings) 323.

In operation S107, the combined patch generator 323 generates a combined patch.

In operation S108, the combined patch generator 323 transmits a notification conveying completion of generation of the combined patch to the system suspender (also denoted by “SUSPENDER” in the drawings) 312.

In operation S109, the system suspender 312 performs a process for suspending system operations, which will be discussed later.

In operation S110, the system suspender 312 transmits a notification conveying completion of suspension of system operations to the combined patch applier (also denoted by “APPLIER” in the drawings) 313.

In operation S111, the combined patch applier 313 applies the combined patch generated by the combined patch generator 323. In other words, in accordance with the determination result determined by the relation checker 322, the combined patch applier 313 applies, during system suspension, the patches determined to have dependencies in order according to the dependencies, and the patches determined not to have dependencies in parallel.

In operation S112, the combined patch applier 313 transmits a notification conveying completion of applying the notification conveying completion of applying the combined patch to the system suspender 312.

In operation S113, the system suspender 312 performs a process for resuming system operations.

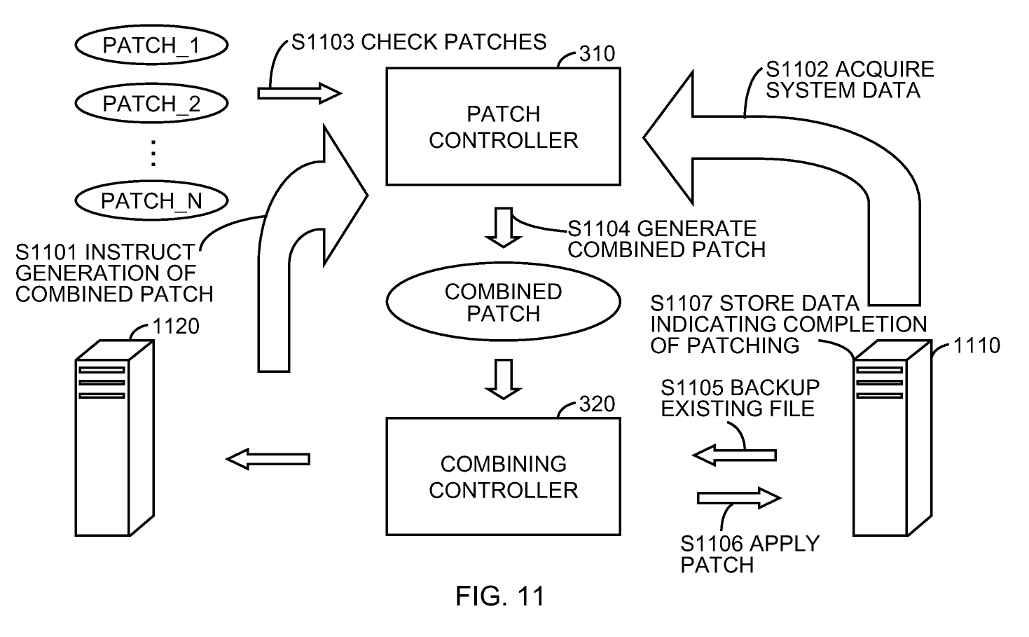

Referring back to FIG. 4, the instruction acceptor 311 connects to the data acquirer 321. FIG. 11 is a diagram illustrating components of a patch application apparatus according to an embodiment of the present invention. The instruction acceptor 311 transmits a instruction for generating a combined patch to the data acquirer 321 as in operation S1101 illustrated in FIG. 11.

FIG. 11 illustrates conceptual relations among processes of the components of the patch application apparatus 100. A target system 1110 illustrated in FIG. 11 is a computer system to which patches are applicable. A backup system 1120 illustrated in FIG. 11 is a computer system that backs up the target system 1110 and holds the backup data.

For example, when the instruction acceptor 311 receives an instruction for applying patches from an administrator, the instruction acceptor 311 controls the target system 1110 such that the normal patching process does not start, and then transmits an instruction for generating a combined patch to the data acquirer 321. Alternatively, the instruction acceptor 311 may control the target system 1110 such that the normal patching process does not start, and then transmit the instruction for generating a combined patch to the data acquirer 321, at a predetermined time defined by the administrator.

The object of controlling the target system 1110 such that the normal patching process does not start is to prevent the operations for applying each of the patches from being performed in parallel with a series of operations of generating a combined patch and applying the combined patch.

The data acquirer 321 connects to the system data storage 201, applied patch data storage 202, instruction acceptor 311, and relation checker 322. When the data acquirer 321 receives the instruction for generating a combined patch from the instruction acceptor 311, the data acquirer 321 reads system data from the system data storage 201 and reads patch IDs from the applied patch data storage 202 as in operation S1102 illustrated in FIG. 11.

For example, the data acquirer 321 may read program information “app1”, “app2”, and “app3”, and an architecture information “arch1” from the system data storage 201.

The data acquirer 321 reads patch IDs of the applied patches from the applied patch data storage 202. For example, the data acquirer 321 may read patch IDs “AA”, “bb”, and “cc”.

The data acquirer 321 transmits the read system data and patch IDs to the relation checker 322. Specifically, the data acquirer 321 transmits the program information, the architecture information, and the patch IDs of the applied patches.

The relation checker 322 connects to the patch storage 203, the data acquirer 321, and the combined patch generator 323. The relation checker 322 receives the program information, the architecture information, and the patch IDs of the applied patches from the data acquirer 321. For example, the relation checker 322 may receive the program information “app1”, “app2”, and “app3”, the architecture information “arch1”, and the patch IDs “AA”, “bb”, and “cc” of the applied patches.

The relation checker 322 further reads all patches stored in the patch storage 203. For example, the relation checker 322 reads the patches “AA” and “BB” from the patch storage 203.

The relation checker 322 further checks the patches stored in the patch storage 203 as in operation S1103 illustrated in FIG. 11. Specifically, the relation checker 322 checks the necessity of applying each patch stored in the patch storage 203 and checks relations between each patch with other patches.

The process of checking the necessity of applying each of the patches stored in the patch storage 203 will be discussed. The relation checker 322 uses the program information, the architecture information, the patch IDs of the applied patches, and the patch information file regarding the patches stored in the patch storage 203 to check the necessity of applying each of the patches.

As an example of the method for checking the necessity of applying each patch, a method that performs various kinds of determination processes and uses the determination results to check the necessity of applying each patch will be discussed below. The method including determinations on whether the hardware architecture satisfies a condition for applying a given patch, whether each program held in the patch application apparatus 100 satisfies a condition for applying the given patch, whether the given patch has been applied, and whether other patches in exclusive relation with the given patch have been applied. The various kinds of determination processes will be discussed first, and then the method that checks the necessity of applying each patch by using the determination results will be discussed.

The process of determination on whether the hardware architecture satisfies a condition for applying the given patch will be discussed. The relation checker 322 determines whether the architecture information list of the read patch includes the architecture information of the patch application apparatus 100.

Taking the case where the architecture information of the patch application apparatus 100 is “arch1” as an example, the process of determination will be discussed. The relation checker 322 determines whether the architecture information list of each patch stored in the patch storage 203 includes “arch1”.

For example, the relation checker 322 may determine that the architecture information lists of the patches (such as patches identified by patch IDs “XX” and “YY”) except the patch “DD” include the architecture information “arch1”. The relation checker 322 may further determine that the architecture information list of the patch “DD” does not include the architecture information “arch1”. In other words, the relation checker 322 may determine that the patches (such as patches identified by patch IDs “XX” and “YY”) except the patch “DD” are applicable for the hardware architecture of the patch application apparatus 100 and that the patch “DD” is not applicable.

The process of determination on whether each program held in the patch application apparatus 100 satisfies a condition for applying the given patch will be discussed. The relation checker 322 determines whether the program information list of the read patch includes any one of program information of the programs held in the patch application apparatus 100.

Taking the case where the program information of the programs held in the patch application apparatus 100 are “app1”, “app2”, and “app3” as an example, the process of determination will be discussed. The relation checker 322 determines whether the program information list of each patch stored in the patch storage 203 includes “app1”, “app2”, or “app3”.

For example, the relation checker 322 may determine that the program information lists of the patches (such as patches identified by patch IDs “XX” and “YY”) except the patch “EE” include one of the program information “app1”, “app2”, and “app3”, and determine that the program information list of the patch “EE” does not include any of them. In other words, the relation checker 322 may determine that the patches (such as patches identified by patch IDs “XX” and “YY”) except the patch “EE” are applicable to the programs held in the patch application apparatus 100 and the patch “EE” is not applicable.

The process of determination on whether the given patch has been applied will be discussed. The relation checker 322 determines whether the patch ID of each applicable patch matches one of the patch IDs read from the applied patch data storage 202. In other words, the relation checker 322 determines whether the patch ID of each applicable patch matches one of the patch IDs of the applied patches.

Taking the case where the patch ID of the applied patch is the patch ID “AA” as an example, the process of determination will be discussed. The relation checker 322 determines whether the patch ID of each patch stored in the patch storage 203 matches the patch ID “AA”.

For example, the relation checker 322 may determine that the patch ID of the patches (such as patches identified by patch IDs “XX” and “YY”) except the patch “AA” do not match the patch ID “AA” and that patch ID of the patch “AA” matches the patch ID “AA”. In other words, the relation checker 322 may determine that the patches (such as the patches identified by patch IDs “XX” and “YY”) except the patch “AA” have not yet been applied and are applicable, and that the patch “AA” has been already applied and is not applicable.

The process of determination on whether other patches in exclusive relation with the given patch have been applied will be discussed. The relation checker 322 determines whether the exclusive patch ID list of each patch stored in the patch storage 203 includes one of the patch IDs of the applied patches.

Taking the case where the patch ID of the applied patch is the patch ID “AA” and the exclusive patch ID list of the patch “CC” includes the patch ID “AA” as an example, the process of determination will be discussed. Here, it is assumed that the exclusive patch ID lists of the patches (such as patches identified by patch IDs “XX” and “YY”) except the patch “CC” do not include any patch ID.

The relation checker 322 may determine that the exclusive patch ID lists of the patches (such as patches identified by patch IDs “XX” and “YY”) except the patch “CC” do not include the patch ID “AA” and also determine that the exclusive patch ID list of the patch ID “CC” includes the patch ID “AA” of the applied patch. In other words, the relation checker 322 may determine that any patches in exclusive relation with the patches (such as the patches identified by patch IDs “XX” and “YY”) except the patch “CC” have not been applied and the patches (such as the patches identified by patch IDs “XX” and “YY”) except the patch “CC” are applicable. The relation checker 322 may also determine that a patch in exclusive relation with the patch “CC” has been applied and the patch “CC” is not to be applied again.

The method of checking the necessity of applying each patch by using the determination results will be discussed. The relation checker 322 selects all patches determined to be applicable for the hardware architecture, determined to be applicable to the programs, determined to be applicable because the patches have not been applied, and determined to be applicable because other patches in exclusive relation have not been applied. For example, the relation checker 322 may select the patches “BB”, “WW”, “XX”, “YY”, and “ZZ” from the patches stored in the patch storage 203.

When there are any patches in exclusive relation with each other among the selected patches, the relation checker 322 excludes one of the patches.

The process of checking relations with other patches will be discussed. In other words, the determination of other patches having dependencies with each of the plural patches to be applied to the target system 1110 during system operations will be discussed.

The relation checker 322 determines whether there are any applicable patches, that is, determines the existence of the selected patches. When it is determined that there are some applicable patches, the relation checker 322 determines the relations between each selected patch and other selected patches. Specifically, the relation checker 322 determines the dependencies and absorption relations.

When it is determined that there are no applicable patches, the relation checker 322 ends the process of generating a combined patch and cancels the control by the instruction acceptor 311, for example. In other words, because the instruction acceptor 311 controls the target system 1110 such that the normal patching process does not start, the relation checker 322 cancels the control.

For example, the relation checker 322 may determine that the patch “XX” has dependencies with the patches “YY” and “ZZ” and that the patch “XX” is to be applied after the patches “YY” and “ZZ” have been applied. The relation checker 322 determines that the patch on which other patches has a dependency is to be applied before the other patches are applied. For example, the relation checker 322 may determine that the patches “YY” and “ZZ” are to be applied before the patch “XX” is applied.

The relation checker 322 may determine that the patch “XX” absorbs the patches “AA” and “BB”. The relation checker 322 excludes the patches absorbed to other patches from the selected patches. The relation checker 322 may exclude the patches “AA” and “BB” from the selected patches, for example.

The relation checker 322 transmits the check result to the combined patch generator 323. Specifically, the relation checker 322 transmits the selected patches and the order, determined for each of the selected patches, of applying the selected patches.

The combined patch generator 323 connects to the combined patch storage 204, the relation checker 322, and the system suspender 312. The combined patch generator 323 receives from the relation checker 322 the selected patches and the order, determined for each of the selected patches, of applying the selected patches. Then, the combined patch generator 323 generates a combined patch during system operations as in operation S1104 illustrated in FIG. 11. The combined patch is a patch resulting from combining the patches the dependencies of which are determined by the relation checker 322. The combined patch generator 323 stores the combined patch in the combined patch storage 204.

The process of generating a combined patch including the applicable patches will be discussed. The combined patch generator 323 generates a combined patch information file. Specifically, the combined patch generator 323 generates an arbitrary combined patch ID. The combined patch generator 323 may generate a combined patch ID “NN”, for example. The combined patch generator 323 aligns the patch IDs of the selected patches, in the determined order of applying, as patch IDs included in the combined patch information file. The combined patch generator 323 associates each of the aligned patch IDs with a dependent patch ID list including the patch IDs of the patches on which the patch identified with the each of the aligned patch IDs has dependencies.

The combined patch generator 323 combines the combined patch information file and the plural patches selected by the relation checker 322 into a combined patch and stores the combined patch in the combined patch storage 204.

The combined patch generator 323 transmits a notification conveying completion of generation of the combined patch to the system suspender 312 and may, for example, transmit the combined patch ID of the combined patch stored in the combined patch storage 204 to the system suspender 312.

The system suspender 312 connects to the combined patch storage 204, the program storage 205, the backup data storage 206, the combined patch applier 313, and the combined patch generator 323.

When the system suspender 312 receives the combined patch ID from the combined patch generator 323, the system suspender 312 performs a backup process for the files to be replaced owing to be applied with the patch as in operation S1105 illustrated in FIG. 11. In other words, the system suspender 312 backs up the files to be replaced owing to be applied with the patch.

After performing the backup process, the system suspender 312 performs a suspension process. After performing the suspension process, the system suspender 312 transmits a notification conveying completion of suspension to the combined patch applier 313. The backup process and the suspension process will be discussed below.

The backup process performed by the system suspender 312 will be discussed. The system suspender 312 reads the file ID list of each of patches included in the combined patch from the combined patch storage 204. The system suspender 312 generates backup data of the files identified with file IDs included in the file ID lists and stores the backup data in the backup data storage 206. In other words, the system suspender 312 generates the backup data of the files to be replaced owing to be applied with the combined patch.

In the example illustrated in FIGS. 9A and 9B, the system suspender 312 reads the file ID list including the file IDs “/xxxxdir/xxxxxxxx1” to “/xxxxdir/xxxxxxxxN” of the patch “XX” included in the combined patch “NN”. Then, the system suspender 312 generates the backup data of the files identified with the file IDs “/xxxxdir/xxxxxxxx1” to “/xxxxdir/xxxxxxxxN” and stores the backup data in the backup data storage 206. The system suspender 312 further generates the backup data of other patches included in the combined patch “NN” than the patch “XX”, and stores the backup data of the other patches to the backup data storage 206.

The system suspender 312 stores in the backup data storage 206 the backup data of the applied patch as patch deletion data which is data to be used in deleting the applied patch.

The suspension process performed by the system suspender 312 will be discussed. After the system suspender 312 has stored all backup data of the combined patch in the backup data storage 206, the system suspender 312 controls such that processes according to programs stored in the program storage 205 may not be performed. For example, the system suspender 312 controls such that instructions from a user may not be accepted.

When the system suspender 312 has received from the combined patch applier 313 a notification conveying completion of applying the combined patch, the system suspender 312 performs a resume process and performs the process to be performed after the patching.

The resume process performed by the system suspender 312 will be discussed. The system suspender 312 stops the control such that processes according to programs stored in the program storage 205 may not be performed, and may control, for example, to accept instructions from a user again.

The process performed by the system suspender 312 after the patching will be discussed. The system suspender 312 stores, during system operations, data regarding the patches which have been applied by the combined patch applier 313 in the storage that stores data regarding patches which have been applied to the target system 1110 as in operation S1107 illustrated in FIG. 11. In other words, the system suspender 312 stores the patch IDs of the patches which have been applied in the applied patch data storage 202. That is, the data indicating completion of patching is stored in the target system 1110.

For example, when the process of applying the combined patch “NN” completes, the patch IDs (such as “XX” and “YY”) of the patches included in the combined patch “NN” may be stored. The system suspender 312 further cancels the control by the instruction acceptor 311. In other words, because the instruction acceptor 311 is controlling the target system 1110 such that the normal patching process may not start, the system suspender 312 cancels the control.

The combined patch applier 313 connects to the applied patch data storage 202, the combined patch storage 204, the program storage 205, and the system suspender 312. When the combined patch applier 313 has received from the system suspender 312 the notification conveying completion of suspension, the combined patch applier 313 reads the combined patch from the combined patch storage 204. The combined patch applier 313 applies the combined patch to each of the programs stored in the program storage 205 as in operation S1106 illustrated in FIG. 11. For example, the combined patch applier 313 may execute the preprocessing script, replace the files, and execute the post-processing script, for each of the patches included in the combined patch.

In accordance with the determination result determined by the relation checker 322, the combined patch applier 313 applies, during system suspension, the patches determined to have dependencies in order according to the dependencies, and the patches determined not to have dependencies in parallel.

The process of applying the combined patch performed by the combined patch applier 313 will be discussed. The combined patch applier 313 applies in parallel the patches determined not to have dependencies with each other. Specifically, the combined patch applier 313 reads each patch ID and corresponding dependent patch ID list from the combined patch information file of the combined patch. Then, the combined patch applier 313 reads and applies the patches identified with such patch IDs that the corresponding dependent patch ID list includes no patch IDs or all the patches corresponding to the patch IDs included in the corresponding dependent patch ID list have been applied. The combined patch applier 313 applies plural patches in parallel, rather than applying one patch after completion of applying another patch.

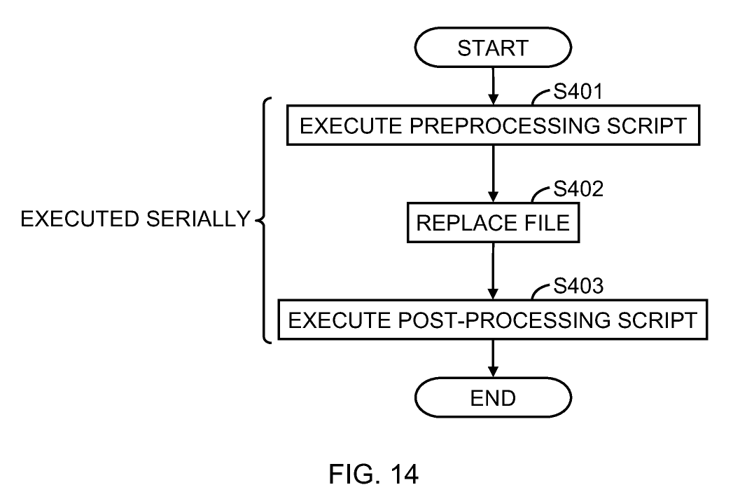

For example, the combined patch applier 313 may refer to the combined patch information file and find the patch IDs “YY” and “ZZ” which have no patch IDs in corresponding dependent patch ID list. Then, the combined patch applier 313 may apply the patches “YY” and “ZZ” in parallel. After completion of applying the patch “YY”, the combined patch applier 313 may start applying the patch “WW” which depends on the patch “YY”. After completion of applying the patches “YY” and “ZZ”, the combined patch applier 313 may start applying the patch “XX”. In the case where only the patch “YY” has been applied but not the patch “ZZ”, the combined patch applier 313 may apply the patch “WW” in parallel with the patch “ZZ”, because the patches “WW” and “ZZ” have no dependencies with each other. In the same manner, the combined patch applier 313 may apply the patches “WW” and “XX” in parallel. The discussion on the process of applying individual patches will be discussed later with reference to FIG. 14 and is thus omitted here.

After applying the combined patch, the combined patch applier 313 transmits to the system suspender 312 the notification conveying completion of applying the combined patch.

In the patching, the target system 1110 is suspended only during the operation S1106 illustrated in FIG. 11, specifically, while executing the preprocessing script, replacing files, and executing the post-processing script. In other words, the target system 1110 is in-service during the other operations are performed.

The patch application apparatus 100 may also be implemented by installing functions of the patch controller 310, combining controller 320, and storage 200 to a known information processing apparatus such as a server, personal computer, workstation, cellular phone, personal handy-phone system (PHS) terminal, mobile communication terminal, and personal digital assistants (PDA).

Process Performed by Patch Application Apparatus

The process performed by the patch application apparatus 100 will be discussed with reference to the drawings. An example of an operation flow of the entire process performed by the patch application apparatus 100 according to the first embodiment, an example of an operation flow of the process performed by the combining controller 320 according to the first embodiment, and an example of an operation flow of the process for applying each patch included in a combined patch performed by the combined patch applier 313 according to the first embodiment will be discussed below.

Entire Process Performed by Patch Application Apparatus

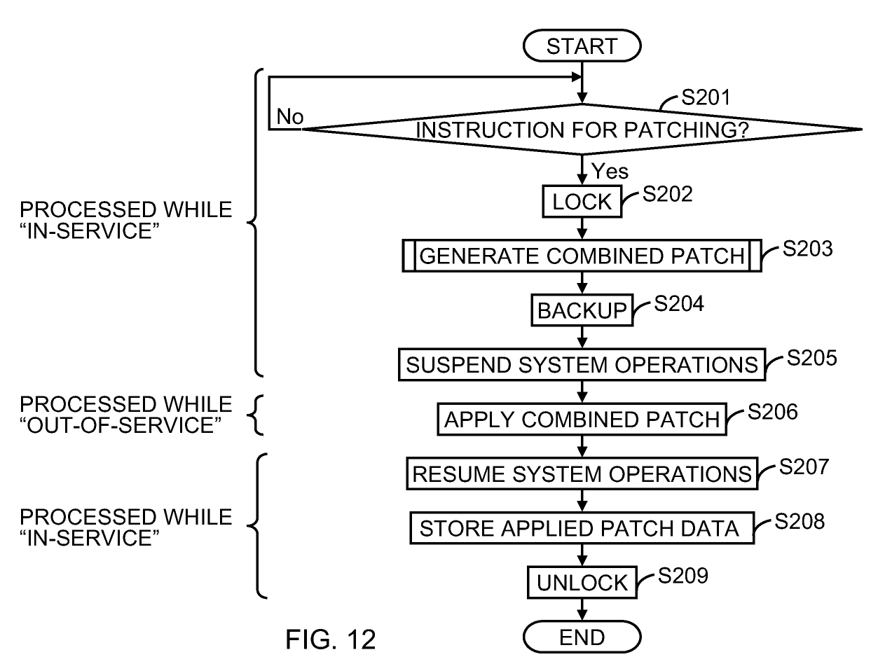

FIG. 12 is a flowchart illustrating an example of an operation flow of an entire process performed by a patch application apparatus according to an embodiment of the present invention. With reference to FIG. 12, an example of an operation flow of the entire process performed by the patch application apparatus 100 according to the first embodiment of the present invention will be discussed. In the discussion with reference to FIG. 12 on an example of an operation flow of the entire process performed by the patch application apparatus 100 according to the first embodiment, the process of generating a combined patch will be discussed briefly.

In operation S201, the instruction acceptor 311 waits for an instruction for patching.

In operation S202, when the instruction acceptor 311 has received the instruction for patching (“Yes” in operation S201), the instruction acceptor 311 locks the patch application apparatus 100 so as to prevent the patch application apparatus 100 from issuing a normal patch command. In other words, the instruction acceptor 311 controls the normal patch process not to start.

In operation S203, the combining controller 320 generates a combined patch and stores the combined patch in the combined patch storage 204. For example, the combining controller 320 may generate a combined patch “NN” and stores the combined patch “NN in the combined patch storage 204.

In operation S204, after the combined patch is generated, the system suspender 312 performs the backup process. That is, the system suspender 312 generates the backup data of the files to be replaced and stores the backup data in the backup data storage 206.

In operation S205, the system suspender 312 performs the suspension process. For example, the system suspender 312 may control the patch application apparatus 100 not to execute the programs stored in the program storage 205.

In operation S206, the combined patch applier 313 applies the combined patch. In other words, the combined patch applier 313 applies, during system suspension, the patches determined to have dependencies in order according to the dependencies, and the patches determined not to have dependencies in parallel.

In operation S207, after completion of applying the combined patch, the system suspender 312 performs the resume process. That is, the system suspender 312 stops the control such that processes according to programs stored in the program storage 205 may not be performed.

In operation S208, the system suspender 312 stores the patch IDs of the applied patches in the applied patch data storage 202. For example, the system suspender 312 may store the patch IDs “XX” and “YY” of the patches included in the combined patch “NN” when the process of applying the combined patch “NN” completes.

In operation S209, the system suspender 312 cancels the control by the instruction acceptor 311. In other words, because the instruction acceptor 311 is controlling the patch application apparatus 100 such that the normal patching process may not start, the system suspender 312 cancels the control.

During the time after the suspension process performed in operation S205 and before the resume process performed in operation S207, the patch application apparatus 100 is out-of-service, that is, in the state that the programs stored in the program storage 205 may not be executed. During the time before operation S205 or after operation S207, the patch application apparatus 100 is in-service, that is, in the state that the programs stored in the program storage 205 may be executed. In other words, among the operations illustrated in FIG. 12, only operation S206 requires the suspension of the system operations.

Process Performed by Combining Controller

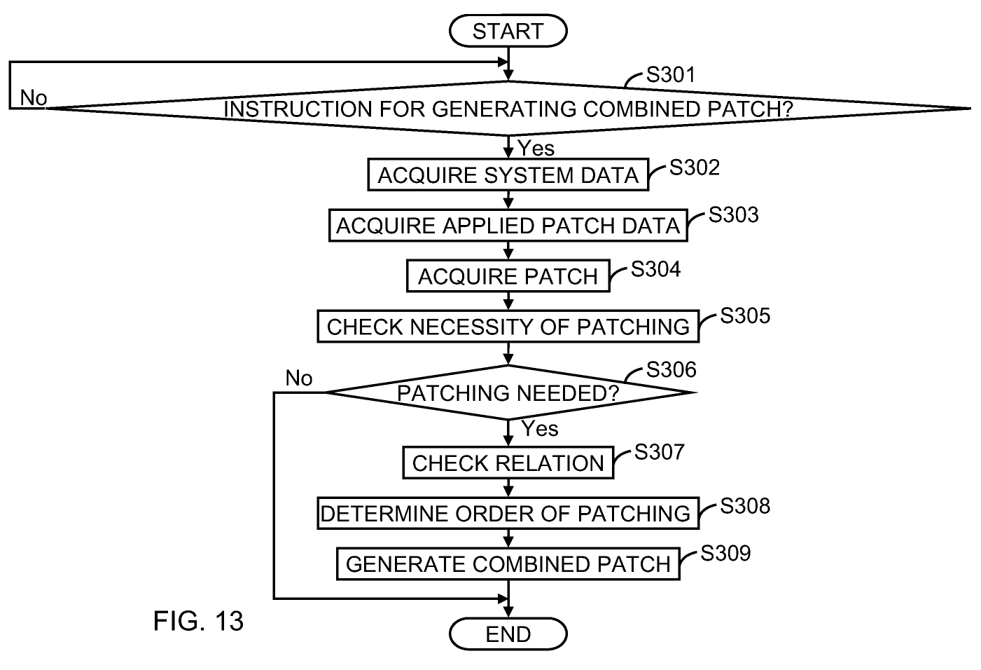

FIG. 13 is a flowchart illustrating an example of an operation flow of a process performed by a combining controller of a patch application apparatus according to an embodiment of the present invention. With reference to FIG. 13, an example of an operation flow of a process, which corresponds to operation S203 illustrated in FIG. 12, performed by the combining controller 320 will be discussed.

In operation S301, the data acquirer 321 waits for an instruction for generating a combined patch.

In operation S302, when the data acquirer 321 has received the instruction for generating a combined patch (“Yes” in operation S301), the data acquirer 321 acquires the system data. For example, the data acquirer 321 may read the program information “app1”, “app2”, and “app3”, and the architecture information “arch1” from the system data storage 201.

In operation S303, the data acquirer 321 acquires data regarding the applied patches. For example, the data acquirer 321 may read the patch IDs “AA”, “bb”, and “cc” of applied patches from the applied patch data storage 202.

In operation S304, the relation checker 322 acquires all of the patches stored in the patch storage 203. For example, the relation checker 322 may acquire the patches “AA” and “BB” from the patch storage 203.

In operation S305, the relation checker 322 checks the necessity of applying each of the patches. Specifically, the relation checker 322 uses the program information, the architecture information, the patch IDs of the applied patches, and the patch information file regarding the patches stored in the patch storage 203 to check the necessity of applying each of the patches. Then, the relation checker 322 selects all patches determined to be necessary. For example, the relation checker 322 may select the patches “BB”, “XX”, and “YY”.

In operation S306, the relation checker 322 determines whether there are any applicable patches, that is, determines the existence of the selected patches. When it is determined that there is no applicable patches (“No” in operation S306), the relation checker 322 ends the process.

In operation S307, when it is determined that there are some applicable patches (“Yes” in operation S306), the relation checker 322 determines the relations between each selected patch and other selected patches than the each selected patch. For example, the relation checker 322 may determine the patch “XX” depends on the patches “YY” and “ZZ” and determine the patch “XX” absorbs the patches “AA” and “BB”.

In operation S308, the combined patch generator 323 determines the order for applying the patches. For example, the combined patch generator 323 determines the order for applying the patches determined to depend on other patches such that the other patches may be applied earlier than the dependent patches.

In operation S309, the combined patch generator 323 combines the applicable patches to generate a combined patch. Specifically, the combined patch generator 323 generates a combined patch information file, combines the plural patches selected by the relation checker 322 and the combined patch information file into a combined patch, and stores the combined patch in the combined patch storage 204.

Process for Applying Each Patch

FIG. 14 is a flowchart illustrating an example of an operation flow of a process of applying patches included in a combined patch performed by a combined patch applier of a patch application apparatus according to an embodiment of the present invention. With reference to FIG. 14, an example of an operation flow of applying patches included in the combined patch performed by the combined patch applier 313 of the patch application apparatus 100 according to the first embodiment will be discussed. In the discussion with reference to concrete examples, it is assumed that the patch “XX” is to be applied.

In operation S401, the combined patch applier 313 executes the preprocessing script. For example, the combined patch applier 313 may execute “scriptBxxxxxxxx”. When the patch does not include the preprocessing script, the combined patch applier 313 does not perform the operation of executing the preprocessing script.

In operation S402, the combined patch applier 313 replaces the files. For example, the combined patch applier 313 may replace the files corresponding to the file IDs “/xxxxdir/xxxxxxxx1” to “/xxxxdir/xxxxxxxxN” with the replacement files “xxxxxxxx1” to “xxxxxxxxN”. When the patch does not include the replacement file list, the combined patch applier 313 does not perform the process of replacing the files.

In operation S403, the combined patch applier 313 executes the post-processing script. For example, the combined patch applier 313 may execute “scriptAxxxxxxxx”. When the patch does not include any post-processing script, the combined patch applier 313 does not perform the operation of executing the post-processing script.

### Effects of the First Embodiment

As discussed above, according to the first embodiment, the patch application apparatus 100 determines for each of the patches applicable to the system other patches having dependencies with the each patch. Then, the patch application apparatus 100 applies the patches determined to have dependencies in order according to the dependencies, and the patches determined not to have dependencies in parallel. As a result, the patches may be applied efficiently.

By applying patches with no dependencies in parallel, the patch application apparatus 100 may reduce the time required for the patching. By performing determination of the dependencies, the patch application apparatus 100 may reduce the amount of processing and the length of time for system suspension.

By storing data regarding the applied patches in the applied patch data storage 202, the patch application apparatus 100 may reduce the length of time for system suspension.

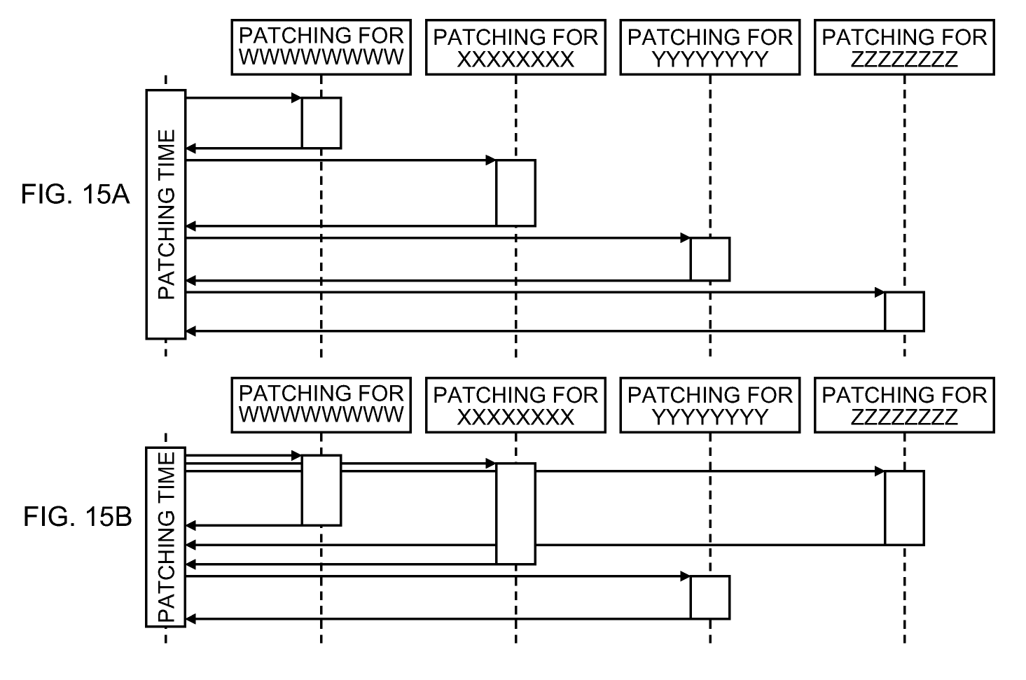

FIGS. 15A and 15B are diagrams illustrating an effect of a patch application apparatus according to an embodiment of the present invention. As illustrated in FIG. 15A, the time required for applying the patches one by one is the total amount of the times for applying each of the patches. However, as illustrated in FIG. 15B, the time required for applying the patches in parallel may require a shorter amount of time than the total amount of the times for applying each of the patches.

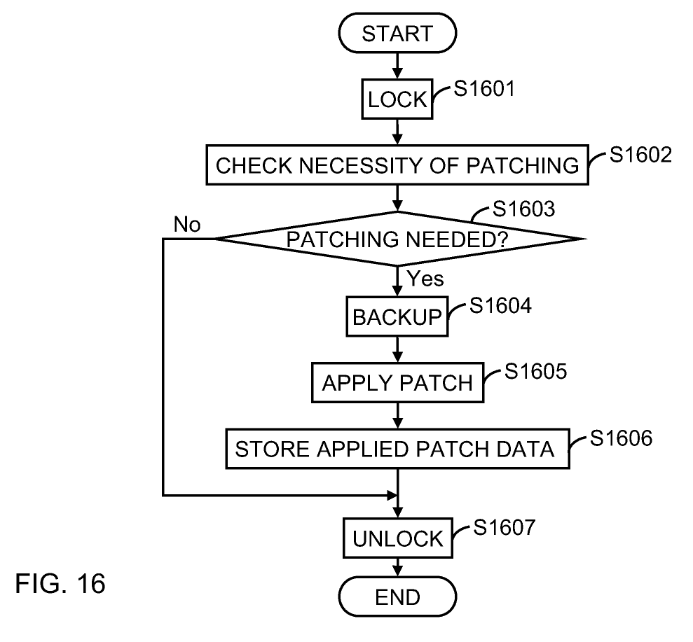

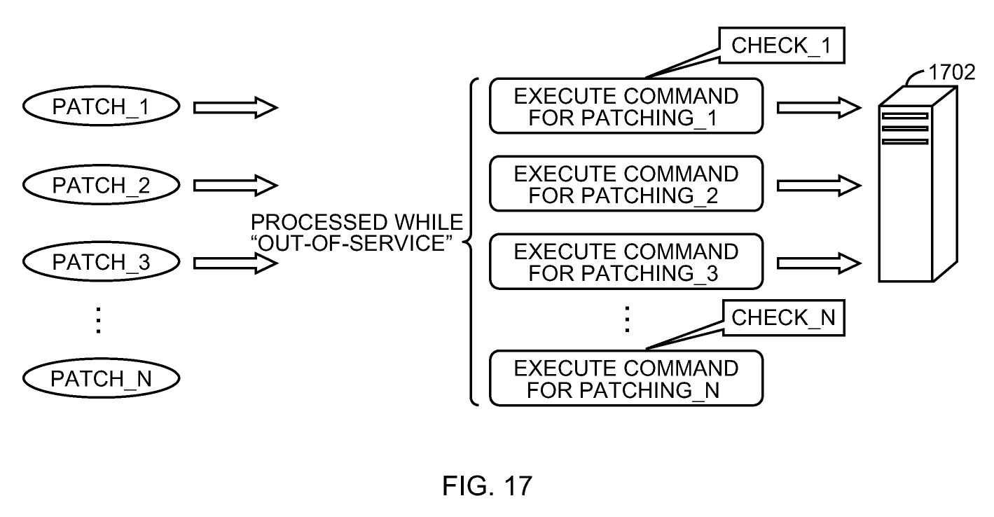

FIG. 16 is a flowchart illustrating an example of an operation flow of a conventional patching process. FIG. 17 is a diagram illustrating an example of a conventional patching process. Traditionally, each of the patches has been applied to the target system 1702 one after another separately through such a process as illustrated in FIG. 16.

In operation S1601, the conventional patch application apparatus locks the target system 1702 so as to prevent the target system 1702 to be applied with other patches than a given patch.

In operation S1602, the conventional patch application apparatus checks the relations between the given patch and other patches.

In operation S1603, the conventional patch application apparatus determines the necessity of applying the given patch.

In operation S1604, when the given patch is applicable (“Yes” in operation S1603), the conventional patch application apparatus performs the backup process.

In operation S1605, the conventional patch application apparatus applies the given patch.

In operation S1606, the conventional patch application apparatus stores the data indicating completion of patching in the target system 1702.

In operation S1607, the conventional patch application apparatus cancels the lock for preventing the target system 1702 to be applied with other patches.

The conventional patch application apparatus suspends, as illustrated in FIG. 17, the target system 1702 while the operations of the conventional patching process illustrated in FIG. 16 are being performed.

On the other hand, according to the first embodiment of the present invention, the patch application apparatus 100 performs the processes of checking the relations of patches and checking the necessity of applying each patch during system operations. The patch application apparatus 100 performs the process of storing the data regarding the applied patches in the applied patch data storage 202 during system operations. As a result, the patch application apparatus 100 performs only the execution of the preprocessing script, the execution of the post-processing script, and the file replacement during system suspension, which may reduce the length of time for system suspension.

Other embodiments as well as the first embodiment may be implemented. The other embodiments will be discussed below.

For example, according to the first embodiment, in addition to the method of applying plural patches in parallel, there have been discussed the method_{—}1: storing the patch ID of the patch applied during system suspension in the storage, and the method_{—}2: combining plural patches to generate a combined patch. However, the embodiments are not limited thereto, but the method_{—}1 and method_{—}2 may not be implemented, or only one of them may be implemented in addition.

System Configuration

Among the processes discussed in the first embodiment, all or a part of the processes discussed as being performed automatically may be performed manually. Alternatively, all or a part of the processes having discussed as being performed manually may be performed automatically by a known method. For example, a combined patch may be generated manually.

In addition, the processes, control processes, specific names and information including data and/or parameters (such as FIGS. 1 to 17) discussed herein or illustrated in the drawings may be changed arbitrarily unless otherwise indicated.

The components of the apparatuses are illustrated functionally and conceptually and are not necessarily required to configure physically as illustrated. In other words, the concrete forms of the distribution and integration of the components are not limited to the illustrated ones, but all or a part of them may functionally or physically be distributed or be integrated in arbitrary units in accordance with the loads and/or the usages.

For example, the patch application apparatus 100 applies a patch to the own patch application apparatus 100 in the first embodiment, however, the patch application apparatus 100 that applies a patch and a computer system to which the patch is applied may be provided as separate apparatuses. For example, the patch controller 310 and the combining controller 320 may be integrated to one controller.

Computer

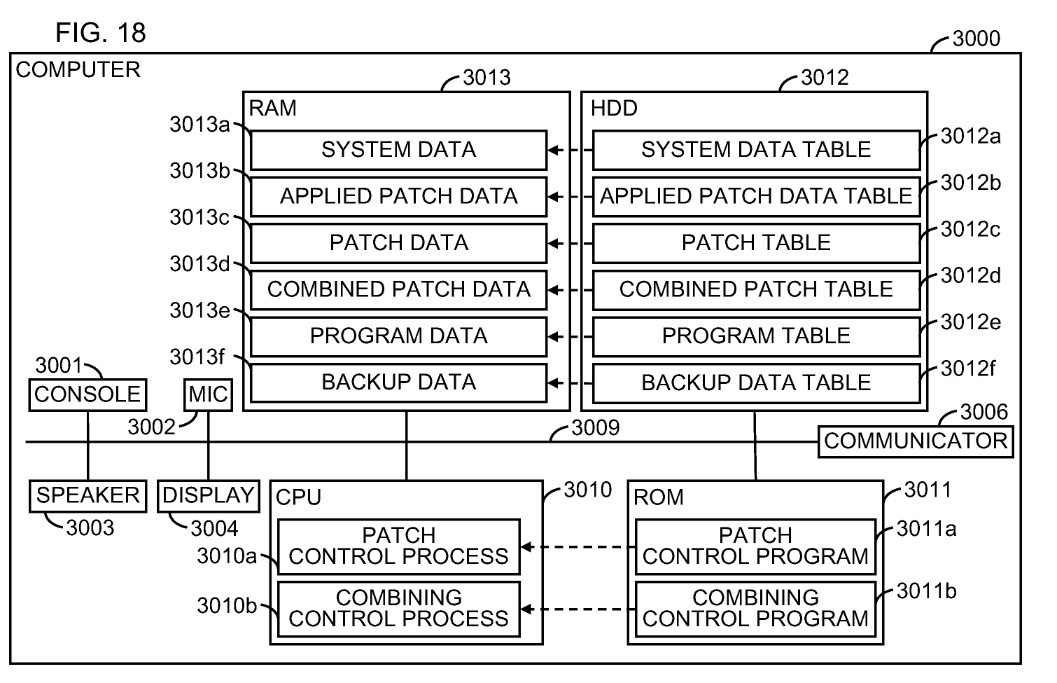

The processes discussed in the embodiments may be implemented by executing prepared programs by a computer functioning as an information processing apparatus such as a server, a personal computer, and a workstation. FIG. 18 is a diagram illustrating a computer that executes a patch program according to an embodiment of the present invention. With reference to FIG. 18, an example of a computer that executes a program for functioning as the patch application apparatus according to the first embodiment of the present invention will be discussed below.

As illustrated in FIG. 18, a computer 3000 acting as the patch application apparatus according to the first embodiment includes an console 3001, a microphone (denoted by “MIC” in the drawings) 3002, a speaker 3003, a display 3004, a communicator 3006, a CPU 3010 functioning as an arithmetic processing unit, a read only memory (ROM) 3011, an hard disk drive (HDD) 3012, a random access memory (RAM) 3013, which are connected via a bus 3009 or the like.

As illustrated in FIG. 18, the ROM 3011 prestores control programs enabling the computer to act as the patch controller 310 and combining controller 320 according to the first embodiment discussed above, that is, a patch control program 3011a and a combining control program 3011b. The programs 3011a and 3011b may be integrated or be distributed as required like the components of the patch application apparatus 100 illustrated in FIG. 4.

The CPU 3010 reads the programs 3011a and 3011b from the ROM 30115 and executes the programs 3011a and 3011b, whereby, as illustrated in FIG. 18, the CPU 3010 may perform a patch control process 3010a and a combining control process 3010b. The processes 3010a to 3010b correspond to the patch controller 310 and combining controller 320, respectively, illustrated in FIG. 4.

The HDD 3012 stores a system data table 3012a, an applied patch data table 3012b, a patch table 3012c, a combined patch table 3012d, a program table 3012e, and a backup data table 3012f. The tables 3012a to 3012f correspond to the system data storage 201, applied patch data storage 202, patch storage 203, combined patch storage 204, program storage 205, and backup data storage 206, respectively, as illustrated in FIG. 4.

The CPU 3010 reads the system data table 3012a, applied patch data table 3012b, patch table 3012c, combined patch table 3012d, program table 3012e, and backup data table 3012f, and stores them in the RAM 3013 as system data 3013a, applied patch data 3013b, patch data 3013c, combined patch data 3013d, program data 3013e, and backup data 3013f, respectively. The CPU 3010 uses the data stored in the RAM 3013 to execute the patch program.

Others

The patch application apparatus 100 according to the embodiments may be implemented by executing prepared programs by a computer such as a personal computer and a workstation. The patch program may be distributed over a network such as the Internet. The patch program may be recorded in a computer-readable medium such as a hard disk, a flexible disk (FD), a compact disk read only memory (CD-ROM), a magneto-optical disk (MO), and a digital versatile disc (DVD), and may be executed by reading it from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A patch application apparatus for applying plural software patches to a computer system, the patch application apparatus comprising:
a relation checker that determines dependencies among the plural software patches; and
a patch applier that
applies first software patches among the plural software patches in parallel to the computer system, each of the first software patches being determined to have no dependency on any other software patch of the plural software patches by the relation checker, and
that applies second software patches among the plural software patches in order according to the dependencies of the second software patches to the computer system, the second software patches being determined to have the dependencies thereamong by the relation checker.

2. The patch application apparatus of claim 1, further comprising:
an applied patch saver that stores data regarding an applied software patch in a storage, the applied software patch having been applied to the computer system by the patch applier.

3. The patch application apparatus of claim 1, further comprising:
a combined patch generator that generates a combined software patch by combining the second software patches,
wherein
the patch applier applies the combined software patch to the computer system.

4. A patch application method executed by a patch application apparatus for applying plural software patches to a computer system, the patch application method comprising:
determining dependencies among the plural software patches;
applying first software patches among the plural software patches in parallel to the computer system, each of the first software patches being determined to have no dependency on any other software patches of the plural software patches in the operation of determining dependencies; and
applying second software patches among the plural software patches in order according to the dependencies of the second software patches to the computer system, the second software patches being determined to have the dependencies thereamong in the operation of determining dependencies.

5. A computer-readable medium storing a program including computer-executable instructions enabling a computer to execute a patch application method, the patch application method being for applying plural software patches to a computer system, the patch application method including:
determining dependencies among the plural software patches,
applying first software patches among the plural software patches in parallel to the computer system, each of the first software patches being determined to have no dependency on any other software patches of the plural software patches in the operation of determining dependencies, and
applying second software patches among the plural software patches in order according to the dependencies of the second software patches to the computer system, the second software patches being determined to have the dependencies thereamong in the operation of determining dependencies.
